(19) United States
(12) Patent Application Publication
(10) Pub. No.: US 2024/0386872 A1
(43) Pub. Date: Nov. 21, 2024

(54) Music Mashup Recommendation and Discovery Tool

(71) Applicant: Peter Kettell, Reno, NV (US)

(72) Inventor: Peter Kettell, Reno, NV (US)

(21) Appl. No.: 18/643,922

(22) Filed: Apr. 23, 2024

Related U.S. Application Data
(60) Provisional application No. 63/461,906, filed on Apr. 25, 2023.

(51) Int. Cl. G10H 1/00

(52) U.S. Cl. CPC G10H 1/0025; G10H 2210/125; G10H 2210/145

(57) ABSTRACT

A music mashup recommendation system is presented, comprising a database of acapella (isolated vocals) and instrumental (no vocals) recordings, wherein the recordings themselves are stored on a third-party service such as YouTube or Spotify and only the links are stored in a database, along with tags that describe the musical composition in detail. The tags are then used to generate recommendations for potential mashups between acapella and instrumental tracks that have a high degree of similarity, so that even a musically untrained user can generate a mashup of good quality. One or both tracks could be selected randomly by the system based on the tags selected.

### CROSS-REFERENCE TO RELATED APPLICATIONS

The present application takes priority from App. No. 63/461,906, filed Apr. 25, 2023, which is incorporated herein by reference.

### BACKGROUND

### Field of the Invention

The present invention relates generally to the creation of musical mashups, and more particularly to web-based recommendation tools for selecting content for mashups.

### Background of the Invention

Many people enjoy making music, and contemporary electronic tools make it much easier for people to experience the joy of musical creativity even if they do not know how to play an instrument. Some of the ways people can enjoy musical creation is by making mashups—taking two separate audio tracks, and overlaying/mixing them over each other.

Due to the complexity of music, it may be difficult for a person to identify two tracks that would fit well enough together to make a mashup. Even if the key and tempo of the tracks are the same, different musical pieces may have different structures (how long the verse is, how long the chorus is, is there an instrumental solo in the middle, and so on and so forth). Putting two tracks together that have significant differences can result in cacophony, making it difficult for some users to identify just what is wrong and why the music sounds bad.

Furthermore, since acapella and instrumental content is scattered and hard to find on the Internet, it is often hard to find just the right two tracks that would result in good matches.

A need exists for a tool to enable a user to easily discover two musical tracks that fit well together in order to make a mashup.

### SUMMARY OF THE INVENTION

An object of the present invention is to enable a user to create musical mashups between two audio tracks that sound good.

Another object of the present invention is to provide a mashup-recommendation tool that gives a user enough information to create a mashup that sounds good without too much adjustment or editing.

Another object of the present invention is to provide a randomized mashup-recommendation tool that automatically selects an instrumental track that matches with a particular acapella track chosen by a user.

Another object of the present invention is to provide a mashup-recommendation tool that enables the creation of mashups through the discovery of audio or video stored on third-party services such as YouTube.

The method of the present invention includes generating tags for audio recordings stored on a third-party website and storing just the tags and links in a database. The tags are parameters describing the audio—the key, tempo, year of composition, artist, genre, length of intro, length of chorus, length of verse, number of verses, length of outro, presence and length of instrumental solos, instrumentation, volume. Some of the recordings are purely acapella; some are purely instrumental. The audio recordings themselves are not stored in the database and can reside on any third-party service for storing audio recordings. A user is prompted to select an acapella track and at least one tag to be matched. The system then selects an instrumental track that matches the at least one tag. A user can make the selection from a set of instrumental tracks that match the tag, or the selection can be made randomly by the computing device. The tracks then may be adjusted to ensure they sound well together, and then played together for the user.

The instrumental track may be selected randomly by a computing device.

The tracks may be adjusted by changing the volume level, pitch, or tempo.

In an embodiment, the audio recordings include video, and the video is displayed for the user at playback.

### LIST OF FIGURES

FIG. 1 shows a sample screenshot from an embodiment of the present invention.

### DETAILED DESCRIPTION

The present invention offers a simple, lightweight system for ensuring that a music production enthusiast can find content in order to create a mashup that sounds good. Because the system does not store the audio or video tracks itself, the database does not take a lot of space and can store a wider variety of musical material.

In brief, the present invention offers a system and method for generating recommendations for musical mashups from separate acapella tracks and separate instrumental tracks. The tracks can be located on any third-party service, such as YouTube, Spotify, or any other commonly used service for storing and sharing audio files. In an embodiment, the tracks also include videos.

In an embodiment, a database is created. The database comprises links to audio recordings of musical pieces, wherein the actual musical recordings are located elsewhere on the Internet—for example, on YouTube, Spotify, or any other third-party website for storing and sharing audio and video content. Some of the recordings are pure vocal recordings—i.e. acapella recordings. Some are pure instrumental recordings, with no vocals. Each link is also accompanied by at least one data tag, wherein the data tag describes certain parameters of the recording, such as key, tempo, year of composition, artist, volume levels, and genre. Some tags are also more detailed in the way they describe the piece and its structure, such as the length of the intro, the length of the chorus, the length of the verse, the length of the outro, the number of verses, the presence or absence of an instrumental solo (or bridge) and its length, and other parameters pertaining to the detailed structure of the piece. It is to be understood that tags are used for the present invention and utilizing them makes it easier for a user to find two matching tracks that won't require a lot of adjustment.

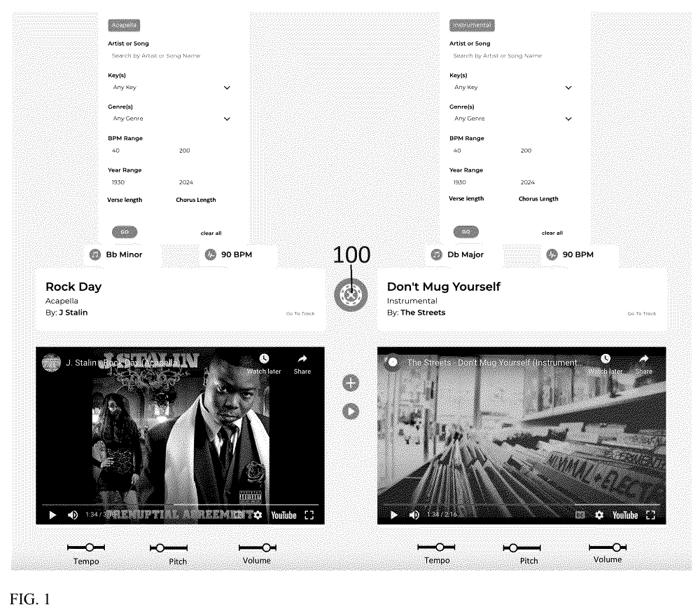

A user wishing to create a mashup would select an acapella track and an instrumental track based on the tags associated with each recording. FIG. 1 shows an embodiment of the system and method of the present invention. In this embodiment, a user would select one acapella track (i.e. isolated vocals) and one instrumental track. For each category, a user would be able to directly enter the name of a song or an artist, key, genre, BPM range, year range, verse length, and chorus length. The system would then search for an acapella or instrumental track that fits those parameters. It will be understood that while the Figure only shows a few tags being used, many more tags can be used for the present invention. For example, a user can select the length of intro, length of outro, number of verses, length of verse, length of chorus, position of instrumental solo, length of instrumental solo, and so on, as tags so that the two tracks line up better and less editing is required to make the two tracks fit together. This makes it possible for users to create something that sounds good without too much adjustment.

In an embodiment, a user could click on a roulette button 100 as shown in the FIGURE and the system would randomly select an acapella track and an instrumental track. As shown in the FIGURE, if no parameters are set, the system simply selects two random tracks (note that the ones shown in the FIGURE are in different keys but the same bpm). If a parameter is set, then the system selects two random tracks that match the parameter. Because of the tagging system of the present invention, selecting two random tracks whose tags match is more likely to result in a potential mashup that is sonically pleasing.

In an embodiment, a user could pick an acapella track and then have the system pick a random instrumental track that matches it based on the tags the user selects. Likewise, a user could pick an instrumental track and then have the system pick an acapella track that matches.

In an embodiment, a user could pick an acapella track and then have the system pick out several options for an instrumental track that matches the tags selected by the user. The user could then select one of the options for the instrumental track.

The tracks may be stored on YouTube, Spotify, or any other music or video sharing service that allows for embedding. The tracks may be created for the present invention or may be pre-existing audio or video recordings available on these services. The tags may be assigned automatically by the software of the present invention, may be assigned manually by human employees, or may be assigned by a user community. In an embodiment, machine learning may be used to analyze each recording to determine what tags are applicable.

Once the user is presented with the two tracks—the acapella and instrumental—they can play them simultaneously as a preliminary matter to see how well they match up. In an embodiment, the user can then adjust one or both of those tracks to make them fit together better—for example, to adjust the volume, to make slight adjustments to the tempo or the pitch, to adjust the timing so they sync up, and so on. Because of the tagging system of the present invention, it is understood that the goal is to require as few adjustments as possible for the recordings to fit together.

In an embodiment where the audio recordings also comprise video (such as YouTube recordings), the videos are displayed for the user on the screen while the two audio tracks play. This may provide extra entertainment for the user.

If the user is satisfied with the two tracks as adjusted, they can then use commonly available digital audio workstation (DAW) software to produce a final mashup. Any DAW software is compatible with the present invention and included in the present disclosure.

An exemplary disclosure is described above. It will be understood that the present invention incorporates other elements that are reasonable equivalents to the above-described disclosure.

1. A method for creating musical mashups, comprising:
generating tags for at least two audio recordings, wherein the at least two audio recordings are stored on a third-party website, wherein the tags are selected from a list comprising:
key, tempo, year of composition, artist, genre, length of intro, length of chorus, length of verse, length of outro, number of verses, presence of instrumental solo, length of instrumental solo, instrumentation, volume;
wherein at least one of the audio recordings is an acapella track;
wherein at least one of the audio recordings is an instrumental track;
storing the tags in a database, wherein each set of tags is associated with a link to an audio recording associated with the tags, wherein the audio recording is not stored in the database but is embedded and playable on the user interface;
selecting an acapella track and at least one tag to be matched;
selecting an instrumental track that matches the at least one tag;
adjusting at least one of the acapella track and the instrumental track to ensure they sound well together;
playing the acapella track and the instrumental track simultaneously.

2. The method of claim 1, wherein the step of selecting an instrumental track that matches the at least one tag comprises:
displaying at least two instrumental tracks that match the at least one tag for a user;
prompting the user to select at least one instrumental track from the at least two instrumental tracks.

3. The method of claim 1, wherein the step of selecting an instrumental track that matches the at least one tag is performed automatically by a computing device.

4. The method of claim 2, wherein the computing device selects at least two instrumental tracks that match the at least one tag and then randomly selects one instrumental track from the at least two instrumental tracks.

5. The method of claim 1, wherein the step of adjusting at least one of the acapella track and the instrumental track comprises adjusting a volume level.

6. The method of claim 1, wherein the step of adjusting at least one of the acapella tracks and the instrumental tracks comprises adjusting a tempo.

7. The method of claim 1, wherein the audio recordings include video.

8. The method of claim 7, wherein the step of playing the acapella track and the instrumental track together comprises displaying a video associated with the acapella track and a video associated with the instrumental track on a user interface.
